(19) United States
(12) Patent Application Publication
(10) Pub. No.: US 2010/0199059 A1
(43) Pub. Date: Aug. 5, 2010

(54) MOBILE COMMUNICATION DEVICE AND METHOD FOR DEFRAGGING MIFARE MEMORY

(75) Inventor: Alexandre Corda, Nice (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/670,699

(22) PCT Filed: Jul. 21, 2008
(86) PCT No.: PCT/IB08/52929

§ 371 Date: Jan. 26, 2010

(30) Foreign Application Priority Data
Aug. 1, 2007 (EP) 07290964.1

(51) Int. Cl. G06F 12/02; H04M 1/00

(52) U.S. Cl. 711/171; 455/550.1; 711/E12.002

(57) ABSTRACT

A mobile communication device (1) is connectable to a classic or emulated MIFARE memory (MM) and comprises a MIFARE applications manager (MAM) which parses the MIFARE memory (MM) for parts of the memory being occupied by MIFARE applications and for empty memory spaces between the occupied parts of the memory. If a predefined number or size of empty memory spaces is detected, the MIFARE applications manager (MIFARE applications manager) does a de-fragmentation of the MIFARE memory (MM) by reorganizing the storage location of MIFARE applications so that they are arranged close together, preferably arranged contiguously.

### FIELD OF THE INVENTION

The invention relates to a mobile communication device being connectable to a classic or emulated MIFARE memory.

The invention further relates to a method for managing MIFARE applications in a mobile communication device being connected to a classic or emulated MIFARE memory.

The invention further relates to a computer program product directly loadable into the memory of a mobile communication device being connectable to a MIFARE device.

The invention further relates to a mobile communication device being connectable to a classic or emulated MIFARE memory, wherein the mobile communication device is adapted to process the computer program product mentioned in the above paragraph.

### BACKGROUND OF THE INVENTION

The MIFARE® classic family, developed by NXP Semiconductors is the pioneer and front runner in contactless smart card ICs operating in the 13.56 MHz frequency range with read/write capability. MIFARE complies with ISO14443 A, which is used in more than 80% of all contactless smart cards today. The technology is embodied in both cards and card reader devices. MIFARE cards are being used in an increasingly broad range of applications (including transport ticketing, access control, e-payment, road tolling, and loyalty applications). MIFARE Standard (or Classic) cards employ a proprietary high-level protocol with a proprietary security protocol for authentication and ciphering.

The MIFARE Classic cards are fundamentally just memory storage devices, where the memory is divided into segments and blocks with simple security mechanisms for access control. Each device has a unique serial number. Anticollision is provided so that several cards in the field may be selected and operated in sequence.

The MIFARE Standard 1 k offers about 768 bytes of data storage, split into 16 sectors with 4 blocks of 16 bytes each (one block consists of 16 byte); each sector is protected by two different keys, called A and B. They can be programmed for operations like reading, writing, increasing value blocks, etc.. The last block of each sector is called “trailer”, which contains two secret keys (A and B) and programmable access conditions for each block in this sector. In order to support multi-application with key hierarchy an individual set of two keys (A and B) per sector (per application) is provided.

The memory organization of a MIFARE Standard 1 k card is shown in FIG. 1. The 1024×8 bit EEPROM memory is organized in 16 sectors with 4 blocks of 16 bytes each. The first data block (block 0) of the first sector (sector 0) is the manufacturer block which is shown in detail in FIG. 2. It contains the serial number of the MIFARE card that has a length of four bytes (bytes 0 to 3), a check byte (byte 4) and eleven bytes of IC manufacturer data (bytes 5 to 15). The serial number is sometimes called MIFARE User IDentification (MUID) and is a unique number. Due to security and system requirements the manufacturer block is write protected after having been programmed by the IC manufacturer at production. However, the MIFARE specification allows to change the serial number during operation of the MIFARE card, which is particularly useful for MIFARE emulation cards like SmartMX cards.

SmartMX (Memory eXtension) is a family of smart cards that have been designed by NXP Semiconductors for high-security smart card applications requiring highly reliable solutions, with or without multiple interface options. Key applications are e-government, banking/finance, mobile communications and advanced public transportation.

The ability to run the MIFARE protocol concurrently with other contactless transmission protocols implemented by the User Operating System enables the combination of new services and existing applications based on MIFARE (e.g. ticketing) on a single Dual Interface controller based smart card. SmartMX cards are able to emulate MIFARE Classic devices and thereby makes this interface compatible with any installed MIFARE Classic infrastructure. The contactless interface can be used to communicate via any protocol, particularly the MIFARE protocol and self defined contactless transmission protocols.

SmartMX enables the easy implementation of state-of-the-art operating systems and open platform solutions including JCOP (the Java Card Operating System) and offers an optimized feature set together with the highest levels of security. SmartMX incorporates a range of security features to counter measure side channel attacks like DPA, SPA etc.. A true anticollision method (acc. ISO/IEC 14443-3), enables multiple cards to be handled simultaneously.

It should be noted that the emulation of MIFARE Classic cards is not only restricted to SmartMX cards, but there may also exist other present or future smartcards being able to emulate MIFARE Classic cards.

Recently, mobile communication devices have been developed which contain MIFARE devices, either being configured as MIFARE Classic cards or as MIFARE emulation devices like SmartMX cards. These mobile communication devices comprise e.g. mobile phones with Near Field Communication (NFC) capabilities, but are not limited to mobile phones.

While the ability of MIFARE Classic cards and MIFARE emulation devices to store multiple MIFARE applications (sometimes also referred to as “MIFARE Classic Objects) have boosted the worldwide propagation and acceptance of MIFARE memory devices (both classic and emulation types) the size limitation in MIFARE memories (usually 1 kB or 4 kB) have turned out to become a bottle neck in the usability of MIFARE memories. This becomes even more severe with the present tendency to develop large MIFARE applications that require more than one sector of a MIFARE memory to be stored therein. What is more, repeated installation/removal/update operations of MIFARE applications in the MIFARE memory result in defragmentation of the MIFARE memory which hinders to install new large MIFARE applications. Such MIFARE applications comprise e.g. coupons, tickets, access controls, etc.. However, the MIFARE applications are not restricted to said application types.

### OBJECT AND SUMMARY OF THE INVENTION

It is an object of the invention to provide a mobile communication device of the type defined in the opening paragraph and a method of the type defined in the second paragraph, in which the problems mentioned above are overcome.

In order to achieve the object defined above, with a mobile communication device according to the invention characteristic features are provided so that such a mobile communication device can be characterized in the way defined below, that is:

A mobile communication device being connectable to a classic or emulated MIFARE memory and comprising a MIFARE applications manager being adapted to parse the MIFARE memory for parts of the memory being occupied by MIFARE applications and for empty memory spaces between the occupied parts of the memory and if a predefined number or size of empty memory spaces is detected, to do a de-fragmentation of the

MIFARE memory by reorganizing the storage location of MIFARE applications so that they are arranged close together, preferably arranged contiguously.

In order to achieve the object defined above, with a method according to the invention characteristic features are provided so that a method according to the invention can be characterized in the way defined below, that is:

A method for managing MIFARE applications in a mobile communication device that is connected to a classic or emulated MIFARE memory (MM), the method comprising:

parsing the MIFARE memory for parts of the memory being occupied by MIFARE applications and for empty memory spaces between the occupied parts of the memory,

and if a predefined number or size of empty memory spaces is detected, to do a de-fragmentation of the MIFARE memory by reorganizing the storage location of MIFARE applications so that they are arranged close together, preferably arranged contiguously.

In order to achieve the object defined above, a computer program product being directly loadable into the memory of a mobile communication device being connectable to a classic or emulated MIFARE memory comprises software code portions for performing—when running on the mobile communication device—the steps of the method for operating a mobile communication device according to the above paragraph.

In order to achieve the object defined above, a mobile communication device according to the invention comprises an arithmetic-logic unit and a memory and processes the computer program product according to the above paragraph.

The present invention allows to overcome the above problems in the environment of mobile communication devices, particularly in a NFC phone environment, by providing de-fragmentation of MIFARE memory so that larger regions of free space in the MIFARE memory is created which allows to install new large MIFARE applications.

Due to the organization of MIFARE memory it is preferred to carry out parsing and defragging of the MIFARE memory on the basis of memory sectors.

There may exist MIFARE applications in the MIFARE memory that require to be stored in a specific sector of the MIFARE memory, since corresponding reading devices search these MIFARE applications only in specific sectors of a MIFARE memory, rather than parsing the entire MIFARE memory. In order to allow continued use of such reading devices the present invention suggests to leave MIFARE applications being recognized as immovable at their original storage location in the MIFARE memory.

The present invention is perfectly suited for mobile phones with NFC capabilities that can be equipped with classic or emulated MIFARE devices, like SmartMX cards.

The aspects defined above and further aspects of the invention are apparent from the exemplary embodiments to be described hereinafter and are explained with reference to these exemplary embodiments.

### BRIEF DESCRIPTION OF THE DRAWINGS

The invention will be described in more detail hereinafter with reference to exemplary embodiments. However, the invention is not limited to them.

FIG. 1 shows the memory organization of a MIFARE Standard 1 k EEPROM.

FIG. 2 shows the manufacturer block of a MIFARE memory.

FIG. 3 shows the sector trailer of a sector of MIFARE memory.

FIG. 4 shows a schematic block circuit diagram of an embodiment of a mobile communication device according to the present invention being equipped with a MIFARE memory.

FIG. 5 shows block diagrams of a MIFARE memory before and after de-fragmentation according to the present invention.

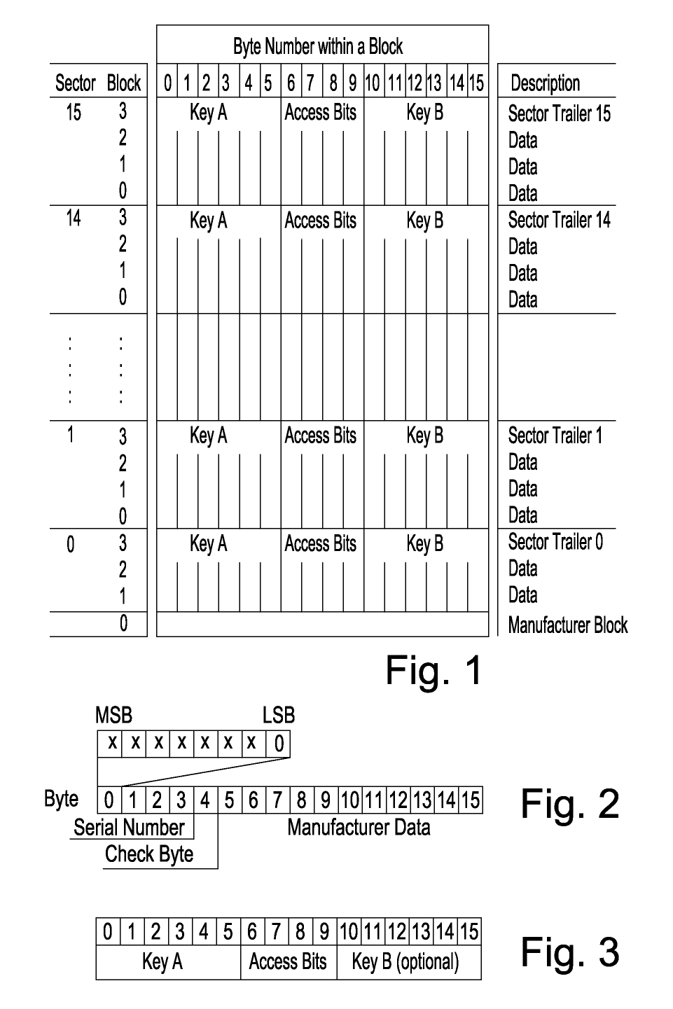

### DESCRIPTION OF EMBODIMENTS

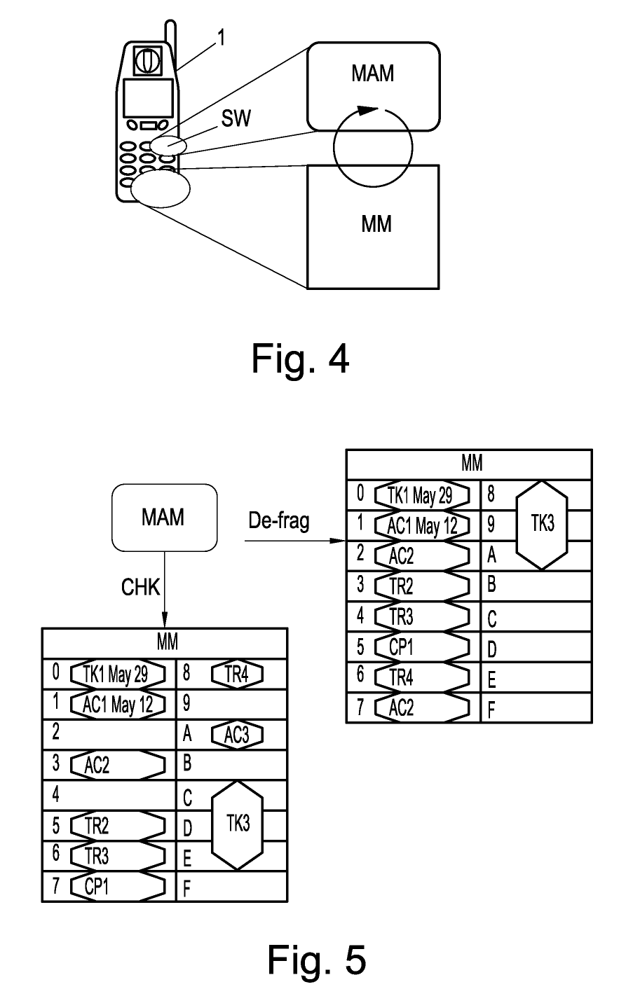

FIG. 4 shows a schematic representation of a mobile communication device 1 being configured as mobile phone with Near Field Communication (NFC) abilities. The mobile communication device 1 comprises a processor and memory (not shown in the drawing) for executing software SW. The software SW comprises an operating system for carrying out and managing all functions of the mobile communication device 1. The mobile communication device 1 is connectable to a MIFARE memory MM which can either be configured as a MIFARE Classic card or a MIFARE Emulation card. The term “connectable to” as used herein means that the MIFARE memory MM is either arranged in an integrated manner in the mobile communication device 1, e.g. being configured as a chip that is arranged on a circuit board of the mobile communication device 1, or the mobile communication device 1 comprises an interface for receiving the MIFARE memory MM in a removable manner in which case the MIFARE memory MM is configured as a card device.

According to the present invention the mobile communication device 1 comprises a MIFARE applications manager MAM. In the present embodiment of the invention the MIFARE applications manager MAM is a software module being contained in the software SW of the mobile communication device 1. The MIFARE applications manager MAM has the ability to parse (arrow CHK) the MIFARE memory MM for parts of the memory being occupied by MIFARE applications and for empty memory spaces between the occupied parts of the memory. For instance, this parsing operation reveals the following result for the MIFARE memory MM occupation shown in FIG. 5 (it is assumed that the MIFARE memory MM is a MIFARE Classic card with 1 kB organized in sixteen sectors:
sector 0x0 occupied by MIFARE ticket application “TK1”;
sector 0x1 occupied by MIFARE access control application “AC1”;
sector 0x2 empty;
sector 0x3 occupied by MIFARE access control application “AC2”;
sector 0x4 empty;
sector 0x5 occupied by MIFARE transit application “TR2”;
sector 0x6 occupied by MIFARE transit application “TR3”;
sector 0x7 occupied by MIFARE coupon application “CP1”;
sector 0x8 occupied by MIFARE transit application “TR4”;
sector 0x9 empty;
sector 0xA occupied by MIFARE access control application “AC3”;
sector 0xB empty;
sectors 0xC to 0cE occupied by large MIFARE ticket application “TK3”;
sector 0xF empty.

It will be appreciated that although there are five sectors free in the MIFARE memory MM it will be impossible to install a single new MIFARE application that requires two sectors or more of storage in the MIFARE memory MM.

The MIFARE applications manager MAM detects this de-fragmentation of the MIFARE memory MM and carries out a de-fragmentation operation (arrow DEF) of the

MIFARE memory MM by reorganizing the storage location of MIFARE applications in the MIFARE memory MM so that they are arranged close together, in this example arranged contiguously. It will be appreciated that due to this de-fragmentation a large region of five contiguous sectors (sectors 0xB to 0xF) has been created allowing to install a new MIFARE application having a size of up to five sectors.

Although not explicitly shown in FIG. 5 the MIFARE memory MM could contain MIFARE applications that have been marked as immovable by a Service Provider or the like. For instance, the MIFARE applications “TK1” and “AC1” in sectors 0x0 and 0x1, respectively, could be such immovable MIFARE applications. The MIFARE applications manager would detect these immovable MIFARE applications and would leave them at their original position in the MIFARE memory MM.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The indefinite article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A mobile communication device being connectable to a classic or emulated MIFARE memory and comprising a MIFARE applications manager being adapted to parse the MIFARE memory for parts of the memory being occupied by MIFARE applications and for empty memory spaces between the occupied parts of the memory and if a predefined number or size of empty memory spaces is detected, to do a de-fragmentation of the MIFARE memory by reorganizing the storage location of MIFARE applications so that they are arranged close together.

2. The mobile communication device -as claimed in claim 1, wherein parsing and defragging of the MIFARE memory is carried out on the basis of memory sectors.

3. The mobile communication device as claimed in claim 1, wherein MIFARE applications being recognized as immovable are left at their original storage location.

4. The mobile communication device as claimed claim 1, wherein the mobile communication device is a mobile phone.

5. A method for managing MIFARE applications in a mobile communication device that is connected to a classic or emulated MIFARE memory, the method comprising:
parsing the MIFARE memory for parts of the memory being occupied by MIFARE applications and for empty memory spaces between the occupied parts of the memory,
and if a predefined number or size of empty memory spaces is detected, to do a de-fragmentation of the MIFARE memory by reorganizing the storage location of MIFARE applications so that they are arranged close together.

6. The method as claimed in claim 5, wherein parsing and defragging of the MIFARE memory is carried out on the basis of memory sectors.

7. The method as claimed in claim 5, wherein MIFARE applications being marked as immovable are left at their original storage location.

8. A computer program product being directly loadable into the memory of a mobile communication device that is connectable to a classic or emulated MIFARE memory, wherein the computer program product comprises software code portions for performing—when running on the mobile communication device the steps of the method as claimed in claim 5.

9. The computer program product as claimed in claim 8, wherein the computer program product is stored on a computer readable medium or is downloadable from a remote server via a:communication network.

10. A mobile communication device with an arithmetic-logic unit and a memory, wherein the mobile communication device is adapted to process the computer program product as claimed in claim 8.

11. The mobile communication device as claimed in claim 10, being configured as a mobile phone, preferably having NFC capabilities.
